(19) United States
(12) Patent Application Publication
(10) Pub. No.: US 2018/0200753 A1
(43) Pub. Date: Jul. 19, 2018

(54) Methods of Forming MLD Films Using Polyols With Long Carbon Backbones

(71) Applicant: Ultratech, Inc., San Jose, CA (US)

(72) Inventor: Mark J. Sowa, Medford, MA (US)

(21) Appl. No.: 15/872,121

(22) Filed: Jan. 16, 2018

Related U.S. Application Data
(60) Provisional application No. 62/446,708, filed on Jan. 16, 2017.

(51) Int. Cl. B05D 1/00

(52) U.S. Cl. CPC B05D 1/60

(57) ABSTRACT

Molecular layer deposition processes for forming organic or hybrid organic/inorganic thin films on a substrate in a reaction chamber that include: providing a pulse of a first vapor phase organic or metal-organic precursor containing a plurality of groups reactive towards hydroxyl groups such that some of the reactive groups react with hydroxyl groups on the substrate to form an organic or hybrid organic/inorganic thin film while leaving some reactive groups available for reaction with a subsequent second precursor pulse; removing excess first reactant and reaction byproducts; providing a pulse of a second vapor phase organic precursor containing a plurality of hydroxyl groups (polyol) such that some of the hydroxyl groups react with the reactive sites of the first precursor on the substrate to form an organic thin film while leaving some hydroxyl groups available for reaction with a subsequent first precursor pulse; and removing excess second reactant and reaction byproducts.

### RELATED APPLICATION DATA

This application claims the benefit of priority of U.S. Provisional Patent Application Ser. No. 62/446,708, filed on Jan. 16, 2017, and titled “METHODS OF FORMING MLD FILMS USING POLYOLS WITH LONG CARBON BACKBONES”, which is incorporated herein by reference in its entirety.

### FIELD

The present disclosure relates to molecular layer deposition (MLD) and in particular relates to methods of forming MLD films using polyols with long carbon backbones.

### BACKGROUND

Atomic layer deposition (ALD) is a thin film deposition technique that involves sequential exposures of a deposition substrate with multiple, distinct chemical and/or energetic environments. A typical process includes the introduction of a precursor gas that has a metal atom that chemisorbs with preexisting chemical moieties on the substrate surface. Following a purge cycle with an inert gas to remove excess precursor and reaction byproducts, a second precursor gas is introduced into the reactor. The second precursor gas is reactive with the chemisorbed portion of the first reactant. A second purge cycle removes excess second precursor gas and reaction byproducts. The second precursor cycle leaves the substrate surface again ready for another exposure of the first precursor gas. This process is repeated to create a conformal film on the substrate surface with sub-atomic layer thickness control.

Molecular layer deposition (MLD) is a specific application of ALD in which one or more of the precursors causes the film to retain a portion of the molecular character of the precursor. MLD can be used to incorporate portions of organic compounds, which can advantageously alter the mechanical, chemical, and electrical characteristics of the deposited film.

### SUMMARY

The disclosure is directed to methods of forming molecular layer deposition (MLD) films using polyols and films made thereby. The properties of the MLD films deposited with the polyol co-reactants employed herein are tuned by selecting the structure and quantity/location of the alcohol groups. Polyol co-reactants with longer carbon backbones produce more flexible films than those with shorter backbones, such as glycerol and ethylene glycol. Polyol co-reactants with more alcohol groups produce less permeable films. 1,2,6-hexane triol and 1,2,4-butane triol are example MLD polyol precursors possessing appropriate reactivity, thermal stability, and vapor pressure. These longer chain polyol MLD co-reactants offer previously unavailable levels of MLD/ALD film flexibility. Selection of alcohol group quantity and backbone location allows refinement of the film flexibility and permeability.

An aspect of the disclosure is an MLD process for forming an organic thin film on a substrate in a reaction chamber. The process can comprise a plurality of organic film deposition cycles, with each cycle comprising the following steps: a) providing a pulse of a first vapor phase organic chemical precursor containing a plurality of reactive groups reactive towards hydroxyl groups such that some of the reactive groups react with hydroxyl groups on the substrate to form an organic thin film while leaving some of the reactive groups available for reaction with a subsequent second precursor pulse; b) removing excess first reactant and reaction byproducts from the reaction chamber; c) providing a pulse of a second vapor phase organic chemical precursor containing a plurality of hydroxyl groups (polyol) such that some of the hydroxyl groups react with the reactive sites of the first precursor on the substrate to form an organic thin film while leaving some hydroxyl groups available for reaction with the subsequent first precursor pulse; and d) removing excess second reactant and reaction byproducts from the reaction chamber.

Another aspect of the disclosure is the method described above, wherein the first reactant contains a plurality of chemical groups reactive towards hydroxyl groups including alkyl, halogen, alkoxy, alkylamides, amidinates, cyclopentadienyls, isocyanate, haloformyl, beta-diketonates, imides, and acetamidinates.

Another aspect of the disclosure is the method described above, wherein the first reactant is 1,4-phenylene diisocyanate.

Another aspect of the disclosure is the method described above, wherein the second reactant is a polyol organic compound having a plurality of hydroxyl groups.

Another aspect of the disclosure is the method described above, wherein the second reactant is 1,2,4-butane triol or 1,2,6-hexane triol.

Another aspect of the disclosure is an MLD process for forming a hybrid organic/inorganic thin film on a substrate in a reaction chamber. The process can comprise a plurality of film deposition cycles, with each cycle comprising: a) providing a pulse of a first vapor phase metal-containing chemical precursor containing a plurality of reactive groups reactive towards hydroxyl groups such that some of the reactive groups react with hydroxyl groups on the substrate to form a hybrid organic/inorganic thin film while leaving some of the reactive groups available for reaction with a subsequent second precursor pulse; b) removing excess first reactant and reaction byproducts from the reaction chamber; c) providing a pulse of a second vapor phase organic chemical precursor containing a plurality of hydroxyl groups (polyol) such that some of the hydroxyl groups react with reactive sites of the first precursor on the substrate to form an organic thin film while leaving some hydroxyl groups available for reaction with a subsequent first precursor pulse; and d) removing excess second reactant and reaction byproducts from the reaction chamber.

Another aspect of the disclosure is the method described above, wherein the first metal-containing reactant contains a plurality of chemical groups reactive towards hydroxyl groups including alkyl, halogen, alkoxy, alkylamides, amidinates, cyclopentadienyls, isocyanate, haloformyl, beta-diketonates, imides, acetamidinates chemicals.

Another aspect of the disclosure is the method described above, wherein the first reactant is trimethylaluminum, tetrakis(dimethylamido) hafnium, tetrakis(dimethylamido) zirconium, tetrakis(dimethylamido) titanium, diethyl zinc.

Another aspect of the disclosure is the method described above, wherein the second reactant is a polyol organic compound having a plurality of hydroxyl groups.

Another aspect of the disclosure is the method described above, wherein the second reactant is 1,2,4 butane triol or 1,2,6-hexane triol.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the Detailed Description explain the principles and operation of the various embodiments. As such, the disclosure will become more fully understood from the following Detailed Description, taken in conjunction with the accompanying Figures, in which:

FIG. 1 is a schematic diagram of an example atomic layer deposition (ALD) process that uses TriMethylAluminum (TMA) (Al(CH₃)₃)) or AlMe₃ and water (H₂O) to deposit Al₂O₃.

FIG. 2 is a schematic diagram of an example process of growing a molecular layer deposition (MLD) film with TMA and glycerol.

FIG. 3A is a chemical diagram of the —OH groups of glycol and illustrating the relatively short carbon backbone for glycol.

FIG. 3B is a chemical diagram of 1,2,6-hexane triol, which has a relatively long carbon backbone.

FIG. 3C is a diagram of 1,2,4-hexane triol, which has a relatively long carbon backbone.

FIG. 4 is a schematic diagram of an example process of growing an MLD film with TMA and 1,2,4-butane triol.

FIG. 5 is a schematic diagram of an example process of growing an MLD film with TMA and 1,2,6-hexane triol.

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure.

The claims as set forth below are incorporated into and constitute part of this Detailed Description.

The term “long carbon backbone” as used herein means a collection of four or more carbon atoms with a linear, branched and/or a ringed structure.

The terms “ALD” and “MLD”, for, respectively, atomic layer deposition and molecular layer deposition, are used interchangeably herein.

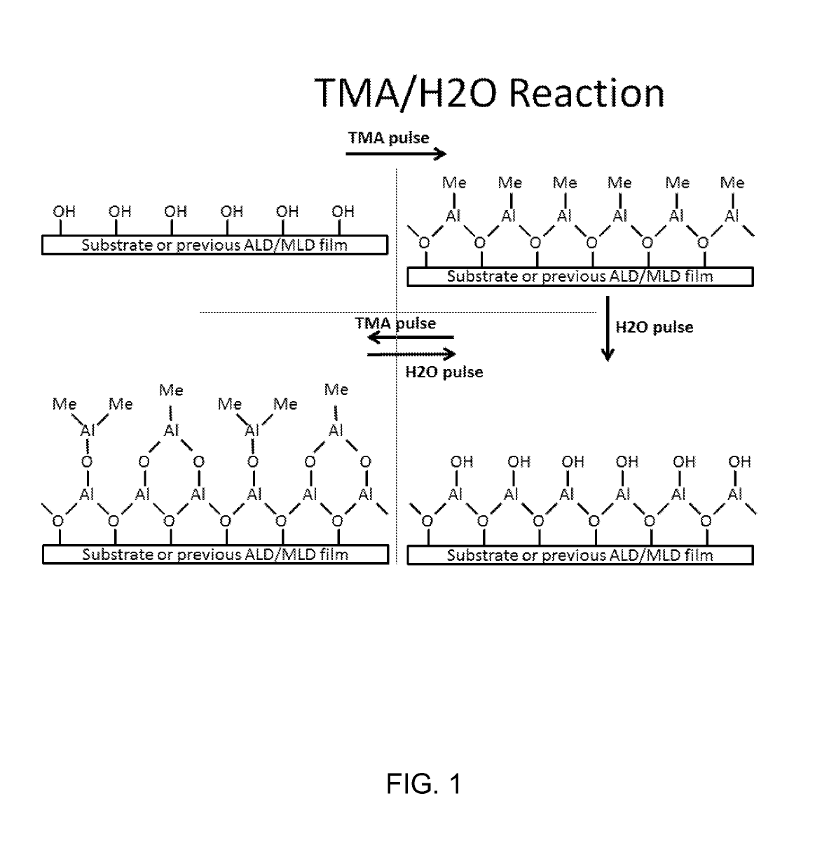

FIG. 1 is a schematic diagram of an example ALD process that uses TriMethylAluminum (TMA) (Al(CH₃)₃)) or AlMe₃ and water (H₂O) to deposit Al₂O₃. The example ALD process is as follows:

Step 1—Pulse TMA into reactor to cause the following reaction with the substrate: Al—OH+Al(Me)₃->Al—O—Al(Me)₂+CH₄.

Step 2—Purge excess TMA and CH₄ from system.

Step 3—Pulse H₂O (H—OH) into reactor to cause the reaction: Al-Me+H—OH—>Al—OH+CH₄.

Step 4—Purge excess H₂O and CH₄ from the system.

Repeat steps 1 through 4 to form multiple molecular layers. It should be recognized that the processes depicted in FIG. 1 and in the other Figures are not two dimensional and extend in and out of the page.

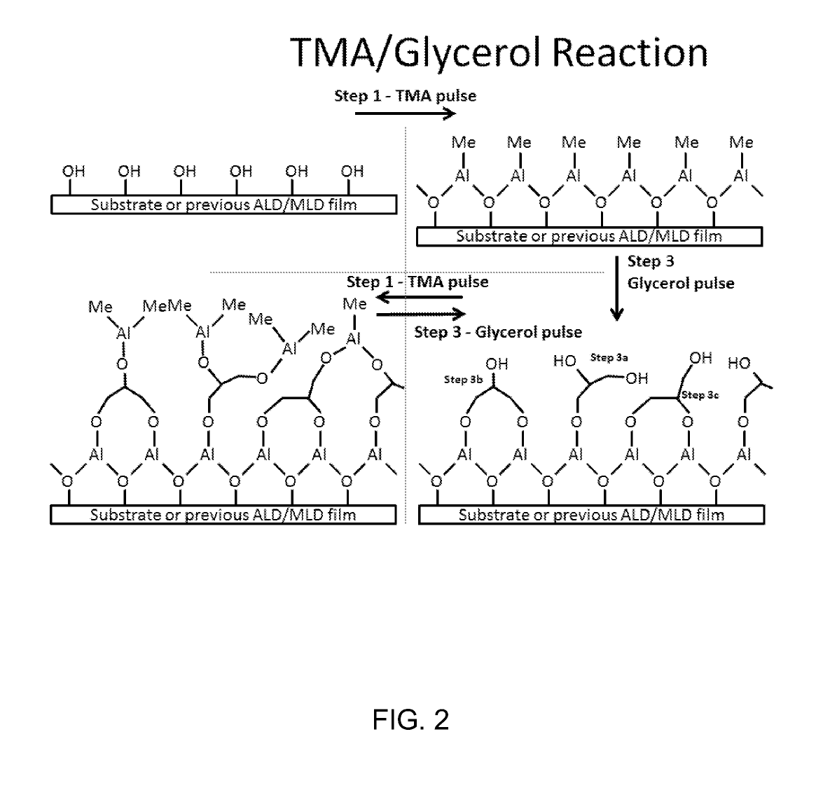

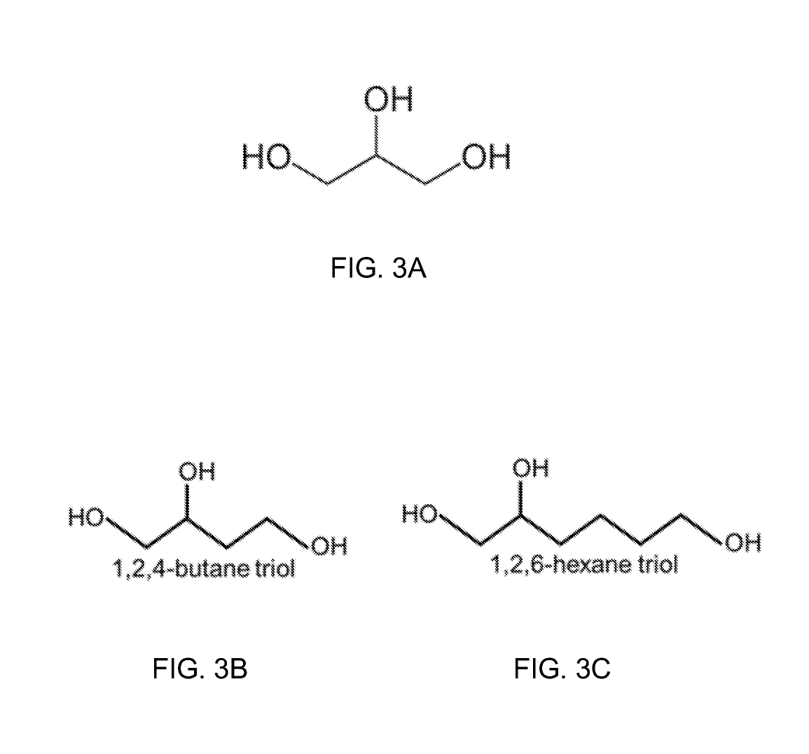

As an example of an MLD process, the H₂O in the previous example can be replaced with glycerol. FIG. 2 is a schematic diagram of an example process of growing an MLD film with TMA and glycerol. The three —OH groups on the glycerol molecule, as shown in the chemical diagram of FIG. 3A, all have the potential to react in an analogous fashion to the —OH groups in Steps 1 and 3 above. However, when the —OH groups in the glycerol molecule react with the —CH₃ groups from the TMA molecule, the 3-carbon backbone of the glycerol molecule becomes incorporated into the growing film.

The process schematically illustrated in FIG. 2 proceeds as follows.

Step 1—Pulse TMA into reactor to cause the reaction: —Al—OH+Al(Me)₃->—Al—O—Al(Me)₂+CH₄.

Step 2—Purge excess TMA and CH₄ from the system.

Step 3—when the glycerol (HO—CH₂C(—OH)HCH₂(—OH)) is introduced, several potential reactions are possible as 1, 2, or 3 —OH groups on the incoming glycerol can react with -Me groups presented on the surface from the chemisorbed TMA. Examples of possible reactions are listed in Step 3a, 3b, 3c.

Step 3a—end —OH group reacts with Al-Me group as follows: —Al—Me+(HO—CH—CHOH—CHOH)—>—AlO—CH—CHOH—CHOH+CH₄.

Step 3b—both end —OH groups react with 2 Al—Me groups as follows: 2(—Al—Me)+(HO—CH—CHOH—CHOH)—>—AlO—CH—CHOH—CHO—Al—+2CH₄.

Step 3c—end and middle —OH groups react with 2 Al-Me groups as follows 2(—Al—Me)+(HO—CH—CHOH—CHOH)—>—Al—O—CH—CH—(O—Al—)—CHOH+2CH₄.

Step 4—Purge excess glycerol and CH4 from system.

The steps 1 through 4 are repeated to form a multi-layer film.

The bottom right schematic of FIG. 2 shows how the glycerol can be bonded to the surface of the substrate in the three different Steps 3a through 3c. It should be recognized that the process is three dimensional and extends in and out of the page. Additional reactions for step 3 not shown are possible, such as only the middle —OH group reacting with the chemisorbed TMA and all three glycerol —OH groups reacting with chemisorbed TMA.

Through the incorporation of the organic 3-carbon chain from the glycerol precursor, the resulting aluminum/glycerol MLD film exhibits more flexibility than a corresponding Al₂O₃ using H₂O as the co-reactant. For example, applying a 2% strain to a 50 nm Al₂O₃ film resulted in 27 cracks per millimeter whereas a higher 2.6% strain applied to an aluminum/glycerol MLD film resulted in no cracking. Similar film strain cracking resistance has been observed with hafnium- and zirconium-based MLD films deposited with glycerol.

Glycerol belongs to a category of organic components referred to as “polyols,” which indicates the organic compound has multiple alcohol (—OH) groups. Many polyols are commercially available. These are characterized by the structure of carbon backbone (linear, branched, rings, combinations thereof), the number of —OH groups (1-alcohol, 2-diol, 3-triol, etc.), and the location of the alcohol groups on the carbon backbone.

Longer carbon backbones provide more flexibility. More —OH groups lead to more cross-linking of the MLD film, which reduces flexibility but improves the film's diffusion barrier characteristics.

Not all polyols having long carbon backbones will be appropriate for MLD processing. Precursors for MLD are delivered to the target substrate in the vapor phase. The precursor must be sufficiently thermally stable such that it will not decompose when heated to produce a vapor phase pressure greater than 0.01 Torr, better greater than 0.1 Torr, and best greater than 1 Torr.

The Table below lists a number of polyols with long carbon backbones, along with their melting-point and vapor-pressure information. It should be noted that structurally similar molecules can have very different melting points, boiling points, and vapor pressures. For example, erythritol and threitol, which are diastereomers of butane with an —OH group on each carbon, have melting points 33° C. apart. These two molecules might produce MLD films with similar properties, but threitol would be a better precursor choice because its lower melting point would make it easier to deliver to the substrate. Precursor selection must take into account the structural as well as the physical characteristics of the molecules.

TABLE

| | | | Boiling Point |
|---|---|---|---|
| | | Melting | (° C.)/Vapor |
| Compound | | Point (° C.) | Pressure |
| ethylene glycol | 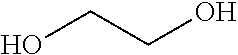 | −13 | 196-198 |
| diethylene glycol | 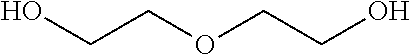 | −10 | 245-246 |
| glycerol | 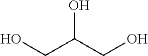 | 18 | 182/20 mm |
| Erythritol | 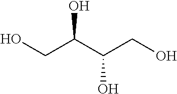 | 121 | 329 |
| Threitol | 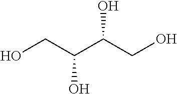 | 88 | |
| D-sorbitol | 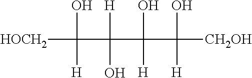 | 98 | 296 |
| Volemitol | 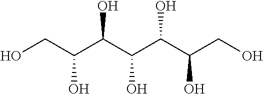 | 152 | |
| Trimethylolpropane | 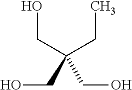 | 58 | 289 |
| 1,2,3-hexane triol | 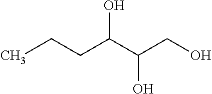 | 64-67 | |
| 1,2,4 butane triol | 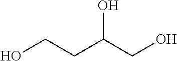 | −20 | 190/18 mm |
| 1,2,6-hexane triol | 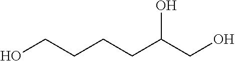 | −20 | 178°/5 mm Hg |
| 1,3 propane diol | 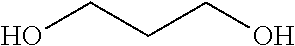 | −26 | 186 |
| 1,4 butane diol | 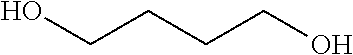 | 6-8 | 131/12 mm |
| 1,2,3-benzenetriol | 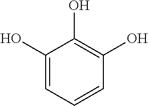 | 131 | 309 |
| 1,2,4-benzenetriol | 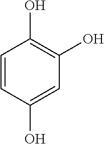 | 140 | |
| 1,3,5-benzenetriol | 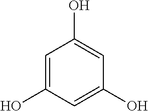 | 219 | |
| Pentaerythritol | 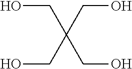 | 260 | |
| Fructose | 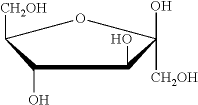 | 103 | |
| Galactose | 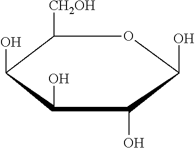 | 167 | |

Two polyol compounds having long carbon backbones that exhibit appropriate properties for performing MLD to form enhanced films according to them methods disclosed herein include: 1,2,6-hexane triol (5 Torr at 178° C.) and 1,2,4-hexane triol (18 Torr at 190° C.). These molecules are shown in the chemical diagrams of FIGS. 3B and 3C respectively, and each has 3 —OH groups, the same as the previously discussed glycerol molecule. However, the additional carbon(s) in the carbon backbone lead to a longer carbon backbone and thus to more flexible MLD films as compared to those deposited with molecules with shorter carbon backbones such as glycerol.

The MLD reactions with TMA and 1,2,4-butane triol are as follows:

Step 1—Pulse TMA into reactor to cause the following reaction on the substrate surface: —Al—OH+Al(Me)₃->Al—O—Al(Me)₂+CH₄.

Step 2—Purge excess TMA and CH4 from system.

In Step 3, when the 1,2,4-butane triol (HO—CH₂C(—OH)HCH₂CH₂(—OH)) is introduced, several potential reactions are possible as 1, 2, or 3 —OH groups on the incoming 1,2,4-butane triol can react with -Me groups presented on the surface from the chemisorbed TMA. More reactions are possible compared to glycerol because the precursor is no longer symmetrical. Examples of possible reactions are listed in Step 3a-3f below.

Step 3a——OH group “1” reacts with Al-Me group per the reaction: —Al—Me+(HO—CH₂—CHOH—CH₂CH₂OH)—>—AlO—CH₂—CHOH—CH₂CH₂OH+CH₄.

Step 3b——OH groups “2” and “4” react with 2 Al-Me groups per the reaction: 2(—Al—Me)+(HO—CH₂—CHOH—CH₂CH₂OH)—>HO—CH₂—CH—(O—Al—)—CH₂CH₂O—Al—+2CH₄.

Step 3c——OH group “2” reacts with Al-Me group per the reaction: —Al—Me+(HO—CH₂—CHOH—CH₂CH₂OH)—>HO—CH₂—CH—(O—Al—)—CH₂CH₂OH+CH₄.

Step 3d——OH groups “1” and “4” react with 2 Al-Me groups per the reaction: 2(—Al—Me)+(HO—CH₂—CHOH—CH₂CH₂OH)—>—AlO—CH₂—CH—OH—CH₂CH₂O—Al—+2CH₄.

Step 3e——OH “4” group react with Al-Me groups per the reaction: (—Al—Me)+(HO—CH₂—CHOH—CH₂CH₂OH)—>HO—CH₂—CHOHCH₂CH₂O—Al—+CH₄.

Step 3f——OH groups “1” and “2” react with 2 Al-Me groups per the reaction: 2(—Al—Me)+(HO—CH₂—CHOH—CH₂CH₂OH)—>—AlO—CH₂—CH—(O—Al—)—CH₂CH₂OH—+2CH₄.

Step 4—Purge excess 1,2,4-butane triol and CH₄ from system.

Repeat steps 1 through 4 to form a film having multiple molecular layers.

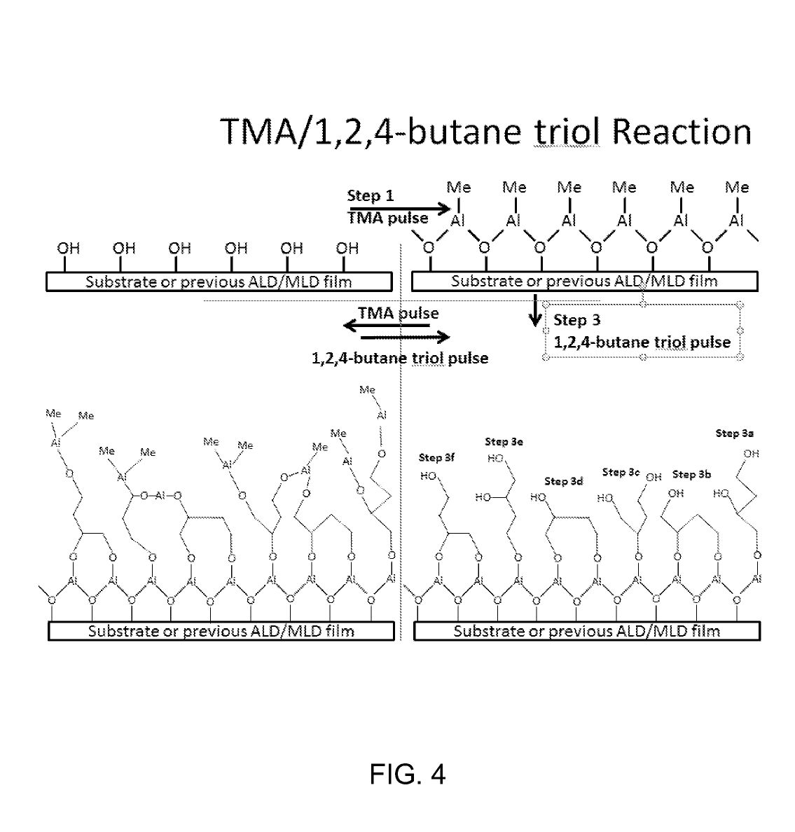

As the precursors become more complex, the number of reaction pathways for the MLD process increases and may be more easily described visually than through chemical reactions. FIG. 4 is a schematic diagram of an example process of growing an MLD film with TMA and 1,2,4-butane triol. The bottom right schematic shows how the 1,2,4-butane triol can be bonded to the surface in the six different steps set forth above. As noted above, the process is three dimensional and extends in and out of the page. Additional reactions for step 3 (not shown in FIG. 4) are possible, such as all three 1,2,4-butane triol —OH groups reacting with chemisorbed TMA.

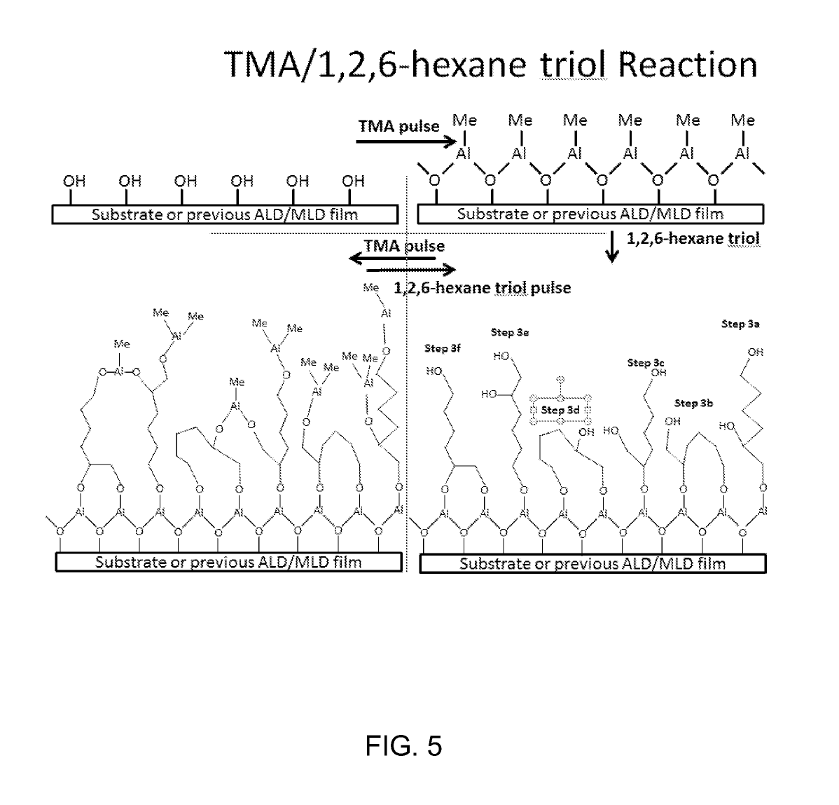

FIG. 5 is a schematic diagram of an example process of growing an MLD film with TMA and 1,2,6-hexane triol.

The various potential reactions allow for various cross-linking scenarios to develop. Such reactions improve the films permeation barrier properties.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. A molecular layer deposition (MLD) process for forming an organic thin film on a substrate in a reaction chamber, wherein the substrate has hydroxyl groups thereon and the process comprising a plurality of organic film deposition cycles, each cycle comprising:
providing a pulse of a first vapor phase organic chemical precursor containing a plurality of reactive groups reactive towards hydroxyl groups such that some of the reactive groups react with the hydroxyl groups on the substrate to form an organic thin film while leaving some of the reactive groups available for reaction with a subsequent pulse of a second vapor phase organic chemical precursor containing a plurality of hydroxyl groups (polyol) such that some of the hydroxyl groups react with reactive sites from the first vapor phase organic chemical precursor on the substrate to form an organic thin film while leaving some hydroxyl groups available for reaction with a subsequent pulse of the first vapor phase organic chemical precursor;
removing excess first reactant and reaction byproducts resulting from the pulse of the first vapor phase organic chemical precursor;
providing a pulse of the second vapor phase organic chemical precursor such that some of the hydroxyl groups react with the reactive sites from the first vapor phase organic chemical precursor on the substrate to form the organic thin film while leaving the some hydroxyl groups available for reaction with the subsequent pulse of the first vapor phase organic chemical precursor; and
removing excess second reactant and reaction byproducts resulting from the pulse of the second vapor phase organic chemical precursor.

2. The process of claim 1, wherein the first reactant contains a plurality of chemical groups reactive towards hydroxyl groups including alkyl, halogen, alkoxy, alkylamides, amidinates, cyclopentadienyls, isocyanate, haloformyl, beta-diketonates, imides, and acetamidinates.

3. The process of claim 2, wherein the first reactant is 1,4-phenylene diisocyanate.

4. The process of claim 1, where the second reactant is a polyol organic compound having a plurality of hydroxyl groups.

5. The process of claim 4, where the second reactant is 1,2,4-butane triol or 1,2,6-hexane triol.

6. A molecular layer deposition (MLD) process for forming a hybrid organic/inorganic thin film on a substrate in a reaction chamber, wherein the substrate has hydroxyl groups thereon and the process comprising a plurality of film deposition cycles, each cycle comprising:
providing a pulse of a vapor phase metal-containing chemical precursor containing a plurality of reactive groups reactive towards hydroxyl groups such that some of the reactive groups react with the hydroxyl groups on the substrate to form a hybrid organic/inorganic thin film while leaving some of the reactive groups available for reaction with a subsequent pulse of a vapor phase organic chemical precursor containing a plurality of hydroxyl groups (polyol) such that some of the hydroxyl groups react with reactive sites from the vapor phase metal-containing chemical precursor on the substrate to form an organic thin film while leaving some hydroxyl groups available for reaction with a subsequent pulse of the vapor phase organic chemical precursor;
removing excess first reactant and reaction byproducts resulting from the pulse of the vapor phase metal-containing chemical precursor;
providing a pulse of the vapor phase organic chemical precursor such that some of the hydroxyl groups react with the reactive sites from the vapor phase metal-containing chemical precursor on the substrate to form the organic thin film while leaving the some hydroxyl groups available for reaction with the subsequent pulse of the vapor phase metal-containing chemical precursor;
removing excess second reactant and reaction byproducts resulting from the pulse of the vapor phase organic chemical precursor.

7. The process of claim 6, wherein the first reactant contains a plurality of chemical groups reactive towards hydroxyl groups including alkyl, halogen, alkoxy, alkylamides, amidinates, cyclopentadienyls, isocyanate, haloformyl, beta-diketonates, imides, acetamidinates chemicals.

8. The process of claim 7, wherein the first reactant is trimethylaluminum, tetrakis(dimethylamido) hafnium, tetrakis(dimethylamido) zirconium, tetrakis(dimethylamido) titanium, diethyl zinc.

9. The process of claim 6, where the second reactant is a polyol organic compound having a plurality of hydroxyl groups.

10. The process of claim 9, where the second reactant is 1,2,4 butane triol or 1,2,6-hexane triol.
